(19) United States
(12) Patent Application Publication
(10) Pub. No.: US 2009/0109696 A1
(43) Pub. Date: Apr. 30, 2009

(54) Modular Vehicle Lighting System

(76) Inventors: Douglas Lembrick, Clinton, MI (US); Derrick Webb, Adrian, MI (US)

Correspondence Address: NOVAK DRUCE AND QUIGG, LLP (Thule), 1000 LOUISIANA STREET, FIFTY-THIRD FLOOR, HOUSTON, TX, 77002, US

(21) Appl. No.: 11/933,052

(22) Filed: Oct. 31, 2007

(51) Int. Cl. B60Q 1/00

(52) U.S. Cl. 362/485

(57) ABSTRACT

A modular vehicle lighting system capable of taking any desired configuration for providing illumination to cargo areas of any size and configuration of accessories comprising at least one light bar having a body defining at least one opening to allow light to allow light to pass from the body to the surrounding vehicle, the light bar also having at least one connection end and at least one connector configured to mate with the light bar connection end whereby an electrical connection between the light bar and the connector is established and at least one bracket for mounting the light bar to a cargo area.

### TECHNICAL FIELD

This technology relates generally to the field of lighting vehicles and more specifically, to the custom-configuration of lighting for vehicle cargo areas and trailers.

The need for adequate lighting of vehicle cargo areas is well known to pickup truck owners. While many vehicles are equipped with some form of cargo area lighting, usually a raised, rear-facing light, these lights present significant drawbacks of poor illumination of the entire cargo area and blinding users/bystanders. For example, many pickup truck style vehicles already have a cargo light mounted into the rear of the cab to illuminate the cargo area by radiating light rearward and down from its mounting position. These lights are insufficient because they focus their light to the middle of the cargo area leaving the sides and corners of the cargo area poorly illuminated. Other aftermarket systems can be mounted atop of the vehicle passenger compartment and may be somewhat adjustable. However, the adjustments are not sufficient to light the entire cargo area, especially those areas closest to the passenger compartment.

Further, both systems have the undesirable effect of impairing the vision of users looking into the cargo area from the rear of the truck. Likewise, other drivers or other bystanders located rear of the truck may have their vision impaired by these rear facing cargo area lighting solutions.

To overcome the aforementioned deficiencies, U.S. Pat. No. 6,238,068 issued to Farmer (the Farmer patent) provides an in-pickup-truck-bed lighting solution which is mounted beneath the guide rails of a typical pickup truck. While the Farmer patent did improve lighting of a pickup-truck bed without impairing the vision of those to the rear of the truck the Farmer patent has several limitations such as having relatively poor configurability to different cargo area shapes and features and inadequate lighting for the portion of a pickup-truck bed closest to the passenger compartment. Therefore there exists a need to provide better illumination for the portion of the cargo area closest to the passenger compartment.

Pickup truck beds come in different sizes and often have various accessories installed making each pickup bed unique to a certain degree. For example, many pickup truck beds have tool boxes installed, or utility racks, or trailer hitches. Past lighting systems poorly illuminate these features or cast shadows which make it even more difficult to adequately view these accessories. In the case of tool boxes, it is further desirable to cast light into the tool box to see its contents.

Additionally, other vehicles and trailers could also benefit from additional lighting. Trailers, for example, often come without any lighting means. In dark environments users struggle to find cargo and tie downs. To alleviate this problem it is desirable to have a lighting system that can fit any trailer. Accordingly, there exists a need to provide an accessory lighting system which is configurable to light pickup truck beds and other cargo areas.

### SUMMARY

A modular vehicle lighting system capable of taking any desired configuration for providing illumination to cargo areas of any size and configuration of accessories comprising at least one light bar having a body defining at least one opening to allow light to allow light to pass from the body to the surrounding vehicle, the light bar also having at least one connection end and at least one connector configured to mate with the light bar connection end whereby an electrical connection between the light bar and the connector is established and at least one bracket for mounting the light bar to a cargo area.

A kit is also provided for a modular vehicle lighting system capable of taking any desired configuration for providing illumination to cargo areas of any size and configuration of accessories comprising at least one light bar having a body defining at least one opening to allow light to allow light to pass from the body to the surrounding vehicle, the light bar also having at least one connection end and at least one connector configured to mate with the light bar connection end and at least one bracket for mounting the light bar to a cargo area.

### BRIEF DESCRIPTION OF THE DRAWINGS

FIG. 1 is a top view of a vehicle having a modular lighting system.

FIG. 2 is an enlarged view of a portion of FIG. 1, with selected areas further enlarged to show greater detail.

FIG. 3 is a picture another view of the embodiment of the vehicle of FIG. 1.

FIGS. 4a, 4b, and 4c are front and side views of a light bar of the lighting system.

FIGS. 5a, 5b, and 5c are front and side views of a light bar of the lighting

FIG. 6 shows front and top views of a light bar with end caps.

FIG. 7 shows an end cap.

FIG. 8 shows a light bar with end caps.

FIG. 9 is an enlarged top view of a portion of a modular light system.

FIG. 10 is an enlarged top view of a portion of a modular light system.

FIG. 11 shows a light bar with a connection element.

FIG. 12 shows a T-three way connector.

FIG. 13 is an enlarged front view of a portion of a modular light system with extension element.

FIG. 14 is a side view of the portion of FIG. 13.

FIG. 15 is an enlarged side view of a portion of FIG. 13.

FIG. 16 is an enlarged side view of a portion of FIG. 13.

FIG. 17 is a bracket of the modular light system.

FIG. 18 is a bracket FIG. 17 with a light bar.

FIG. 19 is a bracket FIG. 17 mounted to vehicle.

FIG. 20 is a bracket FIG. 17 mounted to vehicle.

FIG. 21 is a bracket of the modular light system.

FIG. 22 is a bracket FIG. 21 with a light bar.

FIG. 23 is another view of FIG. 22.

FIG. 24 is a bracket FIG. 21 mounted to vehicle.

FIG. 25 is a bracket FIG. 21 mounted to vehicle.

FIG. 26 is a bracket FIG. 21 mounted to vehicle.

FIG. 27 is a bracket of the modular light system.

FIG. 28 is another view of FIG. 27.

FIG. 29 is a bracket FIG. 27 with a light bar.

FIG. 30 is a front view of the portion of FIG. 29, mounted to a hitch portion.

FIG. 31 is a side view of the portion of FIG. 29.

FIG. 32 is an enlarged top view of a portion of a modular light system.

FIG. 33 is an enlarged view of an end cap of the modular light system.

FIG. 34 is an enlarged front view of a portion of a modular light system.

FIG. 35 is an enlarged view of an end cap of the modular light system.

### DETAILED DESCRIPTION

A modular light system is herein described for the lighting of vehicle cargo areas and in particular pickup truck beds. The modular light system is particularly configured to be adaptable to various sizes and features of the cargo area as well as the needs of the user. As will be described in greater detail below, the modular light system is made up of a series of interchangeable parts which may be assembled in various configurations and also allows for the replacement of worn parts and the addition or removal of parts as required by the user.

A particularly preferred feature of the modular light system is the versatility and usability of the system so that it may accommodate any vehicle or vehicle cargo area and adjust to any additional accessories that might be installed.

The modular light system will be described by reference to the figures, which should not be considered limiting in any way. The figures are presented by way of example only and may portray one or more embodiments of the lighting systems.

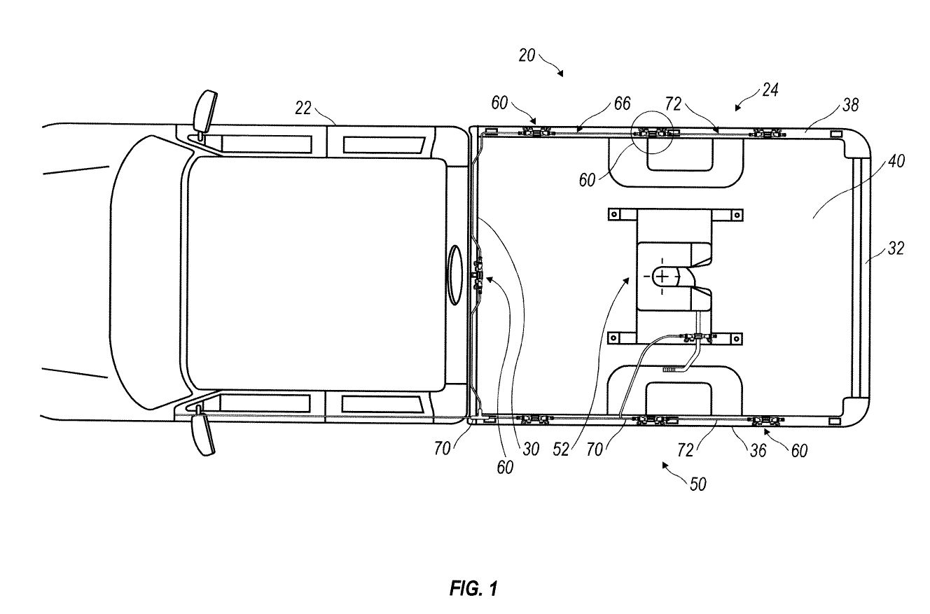

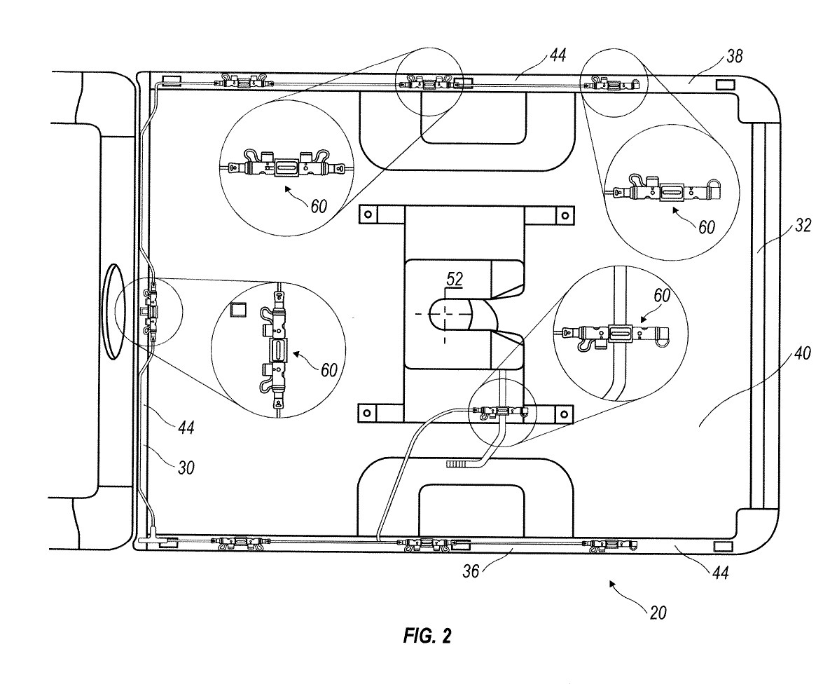

Referring now to FIGS. 1-2, a vehicle 20 is provided having a passenger compartment or cab 22 and a cargo area or bed 24. The cargo area 24 includes a floor 40. The cargo area further includes a front wall 30, a rear wall or tail gate 32, a first side wall 36, a second side wall 38, each having a top surface 44.

Lighting system 50 is disposed within the cargo area 24 of the vehicle 20 to provide lighting to the cargo area 24. The lighting system 50 includes, broadly, a plurality of light bars 60 and a connection system 66 having a plurality of connectors 70 and wiring 72.

As shown in this configuration, the lighting system 50 is shown having one light 60 positioned on front wall 30, and three lights 60 on each side wall 36, 38. Also shown the vehicle bed 24 is fitted with a trailer hitch 52, which has a light 60 mounted to it. This configuration is just one possible configuration. It is conceived that the vehicle bed 24 may or may not have a trailer hitch, and might optionally be fitted with other components such as, but not limited to tool boxes, storage systems, various covers, and utility racks. It is further conceived that different light configurations are possible such as more or less light bars 60 on the walls 36, 38, 32, 30 or various accessories.

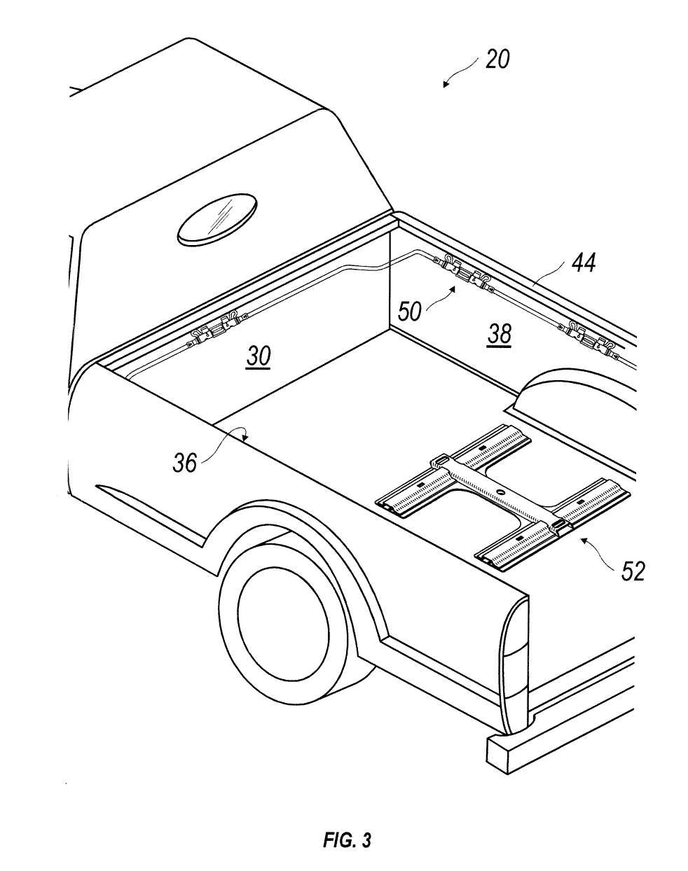

Referring now to FIG. 3 an elevated side view of the vehicle bed 24 is shown. In this embodiment the lighting system 50 is primarily mounted beneath the top 24 of walls 30, 36, 38. The top of walls 44 is shown as being shaped as a rail or having a lip extending a short distance into the center of the vehicle bed 24. Many pickup truck style vehicles have this configuration for the top walls 44 of their cargo areas. In vehicles with this configuration it is desirable to mount lighting system 50 under top walls 44 so keep the lighting system out of view and so as to not take up extra space in the cargo area 24. In those vehicles without rail type top walls, the lighting system 50 can be mounted in any desirable location.

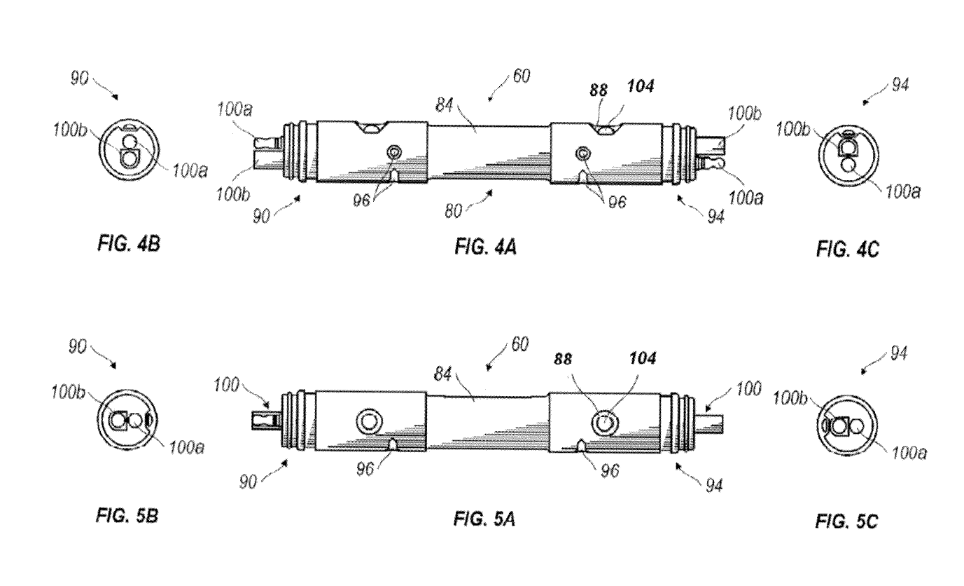

FIG. 4 shows a front view of light bar 60 and FIG. 5 shows a top view of the light bar 60. The light bar 60 includes a generally cylindrical body portion 80 having a central gripping portion 84, a pair of openings 88 recessed into the body 80, a first end 90, a second end 94, and a cap retaining portion 96 formed adjacent each end 90, 94. Each end 90, 94 includes a connector 100 for connecting the light bar 60 to either another light bar 60, or the connection system 66. FIGS. 4b, 4c, 5b, and 5c each show side views of the light bar illustrated in FIGS. 4a and 5a.

Connector 100 is configured to allow for the transport of electrical current between the components of the lighting system and preferably provides a water resistant connection. Connector 100 comprises a first male member 100a and a second female member 100b for electrically conductive mating engagement with connector 100 of another component of the light system such as a light bar 60 or connection system 66. As is well known in the art the female member receives the male member of its complementary connector 100.

The light bar 60 also includes a light source 104 interposed within the body 80 so as to direct light out openings 88. In the embodiment illustrated, the light source 104 is a light emitting diode (LED) that is partially interposed within an opening 88. In still yet other embodiments, the light source can be any other appropriate light source.

The light bar 60 should be of a substantially water resistant construction. As in the pickup truck cargo area embodiment, it is contemplated that the light system 50 will be exposed to various weather conditions and moisture. Therefore, the light bar is constructed of a material and in a design that will protect the light source and electrical components from moisture damage. In one embodiment, the light bar is constructed of a unitary material. In another embodiment, the light bar is constructed of complementary pieces so that the light source or other components can be replaced or repaired and to allow dissipation of heat from the light source.

As seen in FIGS. 4a and 5a, gripping portion 84 is of a lesser diameter than the rest of the housing 84. As will become clearer below in the discussion of the brackets for mounting light bar 60, the lesser circumference prevents side to side motion of light bar 60 when held by a bracket. A further advantage of this design of gripping portion 84 is that the light bar is able to rotate about its longitudinal axis to allow aiming of the light in the desired direction.

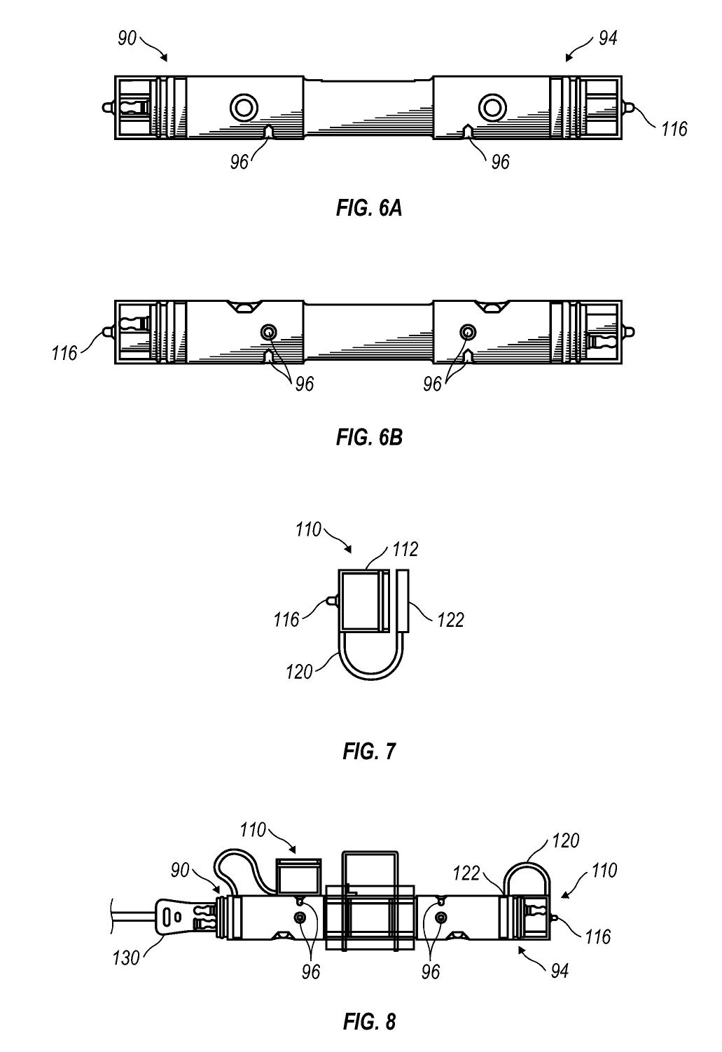

As best seen in FIGS. 6 and 7, the ends 90, 94 may have attached an end cap 110. The end cap 110 includes a generally cylindrical body 112 that is closed at one end 114 and open at the other to receive ends 90, 94 of light bar 60. End cap 110 also has a cap engagement portion or nipple 116 to secure the end cap 110 to the light bar 60 by means of cap-retaining portion 96. As best seen in FIG. 8, when end 94 is not connected to another light bar 60 or connector 130 end 94 is protected by end cap 110. Also shown, end 90 is connected to connector 130 so that end cap 110 is not in use. Instead, end cap 110 is secured to light bar 60 by mating engagement of cap engagement portion to cap-retaining portion 96 to prevent movement of the end cap 110 which may hinder directing light to a desired area or result in damage or misplacement of the end cap 110. The end cap 110 also includes a tether 120 having a connection end 122.

Referring at the same time FIGS. 6 and 8 cap retaining portions 96 are shown. In one embodiment at least two pairs of cap retaining portion 96 are provided for retaining end cap 110. In another embodiment three pairs of cap retaining portion 96 are provided. In still yet another embodiment, more than three pairs of cap retaining portion 96 may be used. Cap retaining portions are spaced around light bar body 80 so as to provide convenient mounting places for end cap 110. However, no cap retaining portion is provided on a face of the light bar 60 that would cause a secured end cap 110 to block light out openings 88. FIG. 8 shows one example of this embodiment wherein end cap 110 is mounted on the back surface of light bar 60 so as to not block light coming from opening 88.

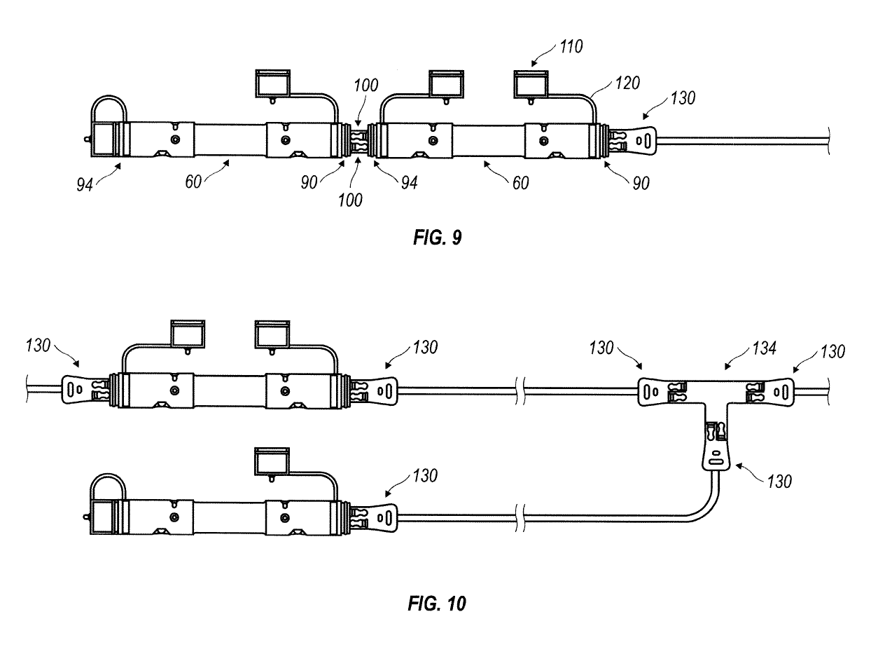

In one generally preferred embodiment of the lighting system 50, there are provided many different connection possibilities to provide a user many different configuration possibilities. FIGS. 9-12 generally show several connection features.

FIG. 9 shows two light bars with end 90 of one light bar connected to end 94 of a second light bar. As shown in this figure, the light bars are connected via complimentary connectors 100. The light bar combination is further connected to a wire-end connector 130. End caps 110 are also shown tethered to the light bar 60 by tether 120.

FIG. 10 shows an additional embodiment of the lighting system, wherein the connection system makes use of a T-three way connector 134 used to connect to wire-end connectors 130. FIG. 12 shows another connection possibility, a three-way-T-connector 134. T-connector 134 comprises three connections for various electrical components of lighting system 50. In this embodiment, each connection has a male member and a female member for mating connection.

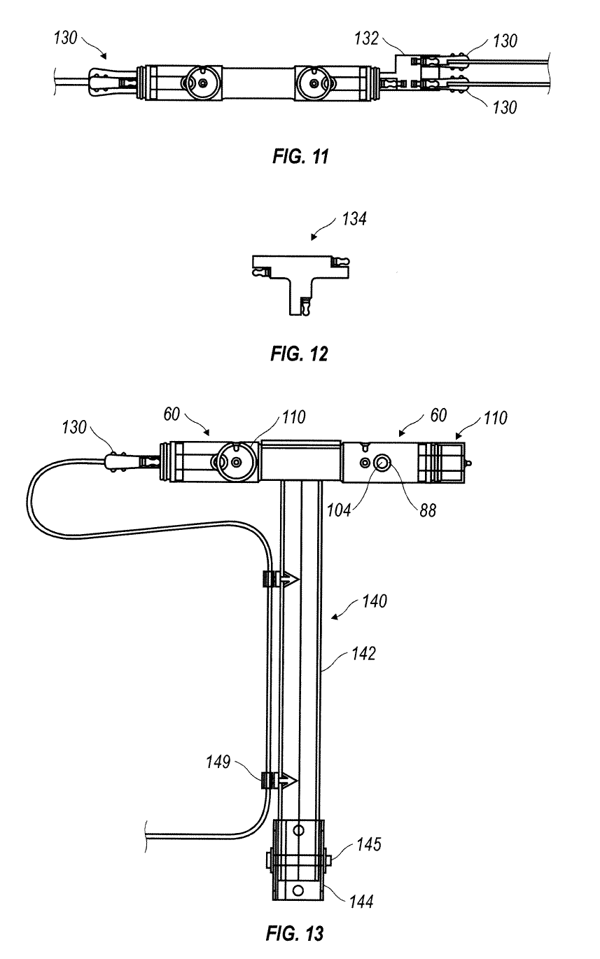

FIG. 11 shows another embodiment of the lighting system 50. In this embodiment, light bar 60 has a linear three-way connector 132. Connector 132 is connected to a light bar and two wire end connectors 130 which connect other electrical components of the light system 50 to the light bar. In one preferred embodiment, every electrical element of the lighting system 50 including but not limited to light bars 60, wire end connectors 130, and three way connectors 132, 134 may be joined to any other electrical component of the lighting system 50. The connections presented in the figures and described herein should not be viewed as limiting. It is conceived that other electrical connection configurations are possible as long as they provide the configurability characteristics according to a preferred embodiment of the lighting system 50.

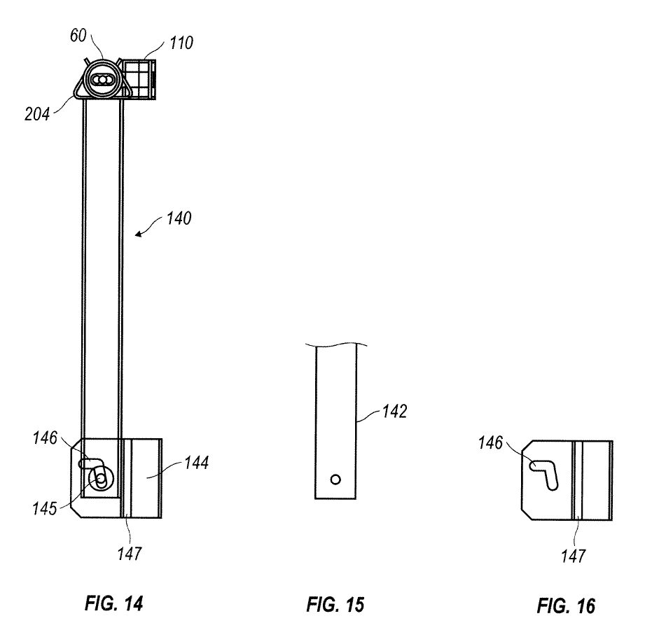

FIG. 13-16 illustrates an embodiment of a light bar 60 including an extension 140. The extension 140 includes a stanchion 142 pivotally mounted to a bracket 144 by means of a pin 145 and channel 146 for adjusting the light bar 60 to direct light to a desired area. Stanchion 142 is connected to bracket 144 at one end by pin 145 which is received in a channel 146 which is adapted to receive the pin 145 and accommodate adjustment to the position of the light bar 60. In one embodiment, pin 145 is removable and is secured when in place by a cotter pin (not shown). At the opposite end, stanchion 142 is connected to clip 148 which secures light bar 60 to stanchion 142. In one embodiment, bracket 204 is secured to stanchion 142 by at least one bolt. Also shown, cap 110 is secured to light bar via interaction between nipple 116 and recess 96 as previously described. Another feature is wire holder 149, which keeps wire from getting tangled on extension 140 or cargo as the extension is manipulated into a desired position.

The bracket is configured to be mounted to a cargo area, vehicle, or accessory. Its function is most easily understood when explained in the context of the bracket 144 being mounted to wall 30 of vehicle 20. In such a situation, the stanchion 142 will hold the light bar above the bed of a pickup truck in a substantially vertical position. The stanchion 142 is locked into this substantially vertical position by bracket 144. Bracket 144 comprises a stop 147 which works in conjunction with channel 146 to hold stanchion 142 in place. In one embodiment, stop 147 comprises an angled portion of the bracket. In another embodiment, the stop comprises a resilient biased material that will accommodate movement of stanchion, but be biased into its original relaxed state to secured stanchion 142 in place.

When additional lighting is required in the pickup truck bed, the extension 140 can rotate on pin 145 within channel 146 to be held in at least substantially ninety degree and substantially 180 degree angles, from the starting vertical position. In an alternate embodiment, the stanchion may be rotated and held in any desired position. Since light bar 60 can rotate within clip 148 the light bar can be adjusted to provide light to the desired area in any position which the extension is rotated.

It should be understood that extension 140 is able to be mounted to any other wall of a pickup truck bed, or a trailer, accessory for a pickup truck bed or trailer, or any cargo area.

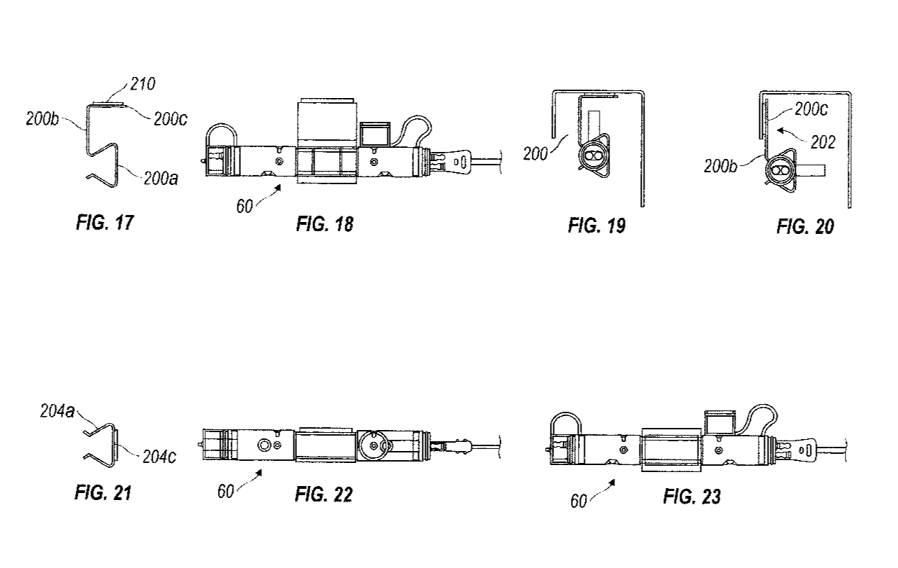

FIGS. 17-31 illustrate brackets 200, 202, 204, 204 used to secure the light bar 60 to desired surfaces, such as portions of the hitch 52 or the vehicle 20. In the embodiment illustrated, the brackets 200, 202, 204, 204 may include a magnet 210 or a clasp 212 to easily move the light bar 60 to another desired area, although other suitable connecting means may be used to couple the light bar 60 to the vehicle 20.

Referring now to FIGS. 17-19 bracket 200 is shown in various views. Bracket 200 has a spring portion 200a for holding light bar 60, extension portion 200b for extending light bar 60 away from the mounting point, and mounting portion 200c. As shown in FIG. 17, mounting portion has a magnet 210 for use as the mounting mechanism. In another embodiment, the mounting portion may attach to a mounting surface by a bolt, screw, polymer or any other suitable mounting means.

Spring portion 200a is configured to be biased in a semi-closed configuration that may be forced into a more open configuration to receive light bar 60 and by the nature of a spring secure the light bar to the bracket 200 as the spring portion 200a returns to its relaxed/unloaded configuration. As shown in FIG. 19, one conceived use for bracket 200 is mount the bracket under the rail-type top surface 44 and extend the light bar below the rail so as to not obstruct the light.

FIG. 20 shows another embodiment of a bracket 202. Bracket 202 is similar to bracket 200 except that its mounting portion 202c is in line with extending portion 202b.

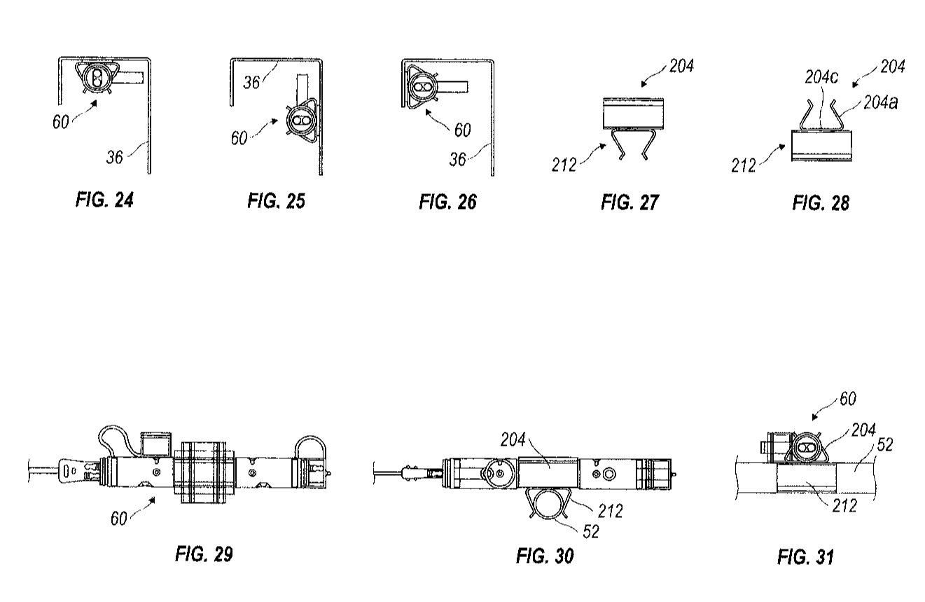

FIGS. 21-26 show bracket 204 which is again similar to bracket 200 except that bracket 204 lacks an extending portion and its mounting portion 204c is part of the spring portion 204a. As shown in FIG. 24-26, the bracket 204 is conceived to be mounted under rail-type top surface 44, inside top surface 44, or on a wall of the cargo area. It should be understood that this bracket is particularly useful to mount light bar 60 to any surface where no extension is necessary.

FIGS. 27-31 show bracket 204. FIG. 28 shows spring portion 204a and mounting portion 204c with clasp 212 attached. Clasp 212 is best viewed in FIG. 27, where it can be seen that clasp 212 is very similar, or it may even be the same as bracket 204. This mounting mechanism is particularly useful when mounting light bar 60 to accessories or trailers or other objects which clasp 212 is suited to grasping. One such example is shown in FIGS. 29 and 30 wherein clasp 212 secures light bar 60 to trailer hitch 52. FIG. 31 shows a portion of FIG. 32 from a side angle to show the relationship between bracket 204 and light bar 60.

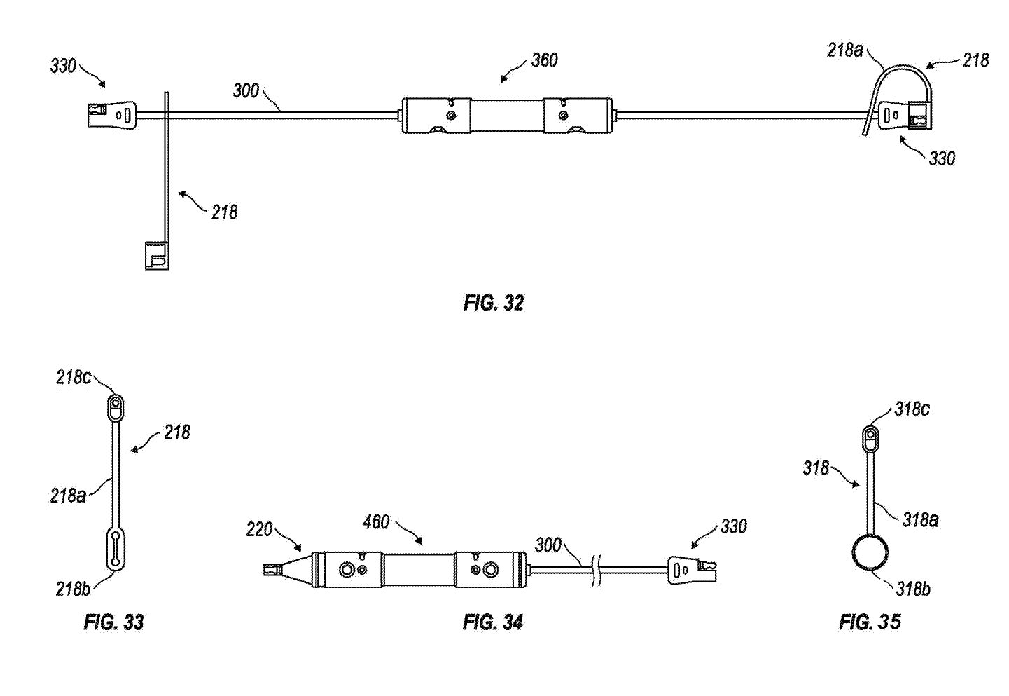

FIGS. 32-33 illustrate protective caps 218 for light bar 360 having connectors 300 integral therewith. In particular, FIG. 40 shows light bar 360, with wire connectors 300 on either side. Wire connector 300 at first side of light bar 360 is shown with protective cap 218 in its protective orientation, covering wire-end 330. At the opposite end, wire connector 300 is shown with protective cap tethered itself, but protective cap 218 is unused. When protective cap is not needed, tether 218a prevents loss of protective cap 218 by securing one end to wire-end 330. FIG. 33 shows protective cap 218. In particular FIG. 44 shows wire securing end 218b, tether 218a and cap portion 218c of protective cap 218.

FIG. 34 also illustrates another embodiment of a light bar 460 having one end fitting 220 at one end and a wire connector 300 at its other end. FIG. 35 shows an alternate end cap 318 for use with light bar 460. End cap 318 has a light bar securing end 318b, tether 318a and cap portion 318c.

The lighting system 50 may be powered by any conventional and well known means. In a preferred embodiment, the lighting system 50 is powered by the vehicle's electrical system and/or battery. In yet another embodiment, the lighting system 50 may be powered by an external battery, or rechargeable battery.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention, In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

1. A modular vehicle lighting system capable of taking any desired configuration for providing illumination to cargo areas of any size and configuration of accessories comprising:
at least one light bar having a body defining at least one opening to allow light to allow light to pass from the body to the surrounding vehicle, the light bar also having at least one connection end;
at least one connector configured to mate with the light bar connection end whereby an electrical connection between the light bar and the connector is established; and
at least one bracket for mounting the light bar to a cargo area.

2. A kit for a modular vehicle lighting system capable of taking any desired configuration for providing illumination to cargo areas of any size and configuration of accessories comprising:
at least one light bar having a body defining at least one opening to allow light to allow light to pass from the body to the surrounding vehicle, the light bar also having at least one connection end;
at least one connector configured to mate with the light bar connection end; and
at least one bracket for mounting the light bar to a cargo area.
